(19) United States
(12) Patent Application Publication
(10) Pub. No.: US 2016/0371118 A1
(43) Pub. Date: Dec. 22, 2016

(54) VIRTUAL MACHINE MANAGEMENT METHOD AND APPARATUS INCLUDING IDLING AND SCHEDULING OF VIRTUAL PROCESSORS

(71) Applicant: Intel Corporation, Santa Clara, CA (US)

(72) Inventors: Vijay Dhanraj, Hillsboro, OR (US); Abhinav R. Karhu, Hillsboro, OR (US); Gaurav Khanna, Hillsboro, OR (US); Russell J. Fenger, Beaverton, OR (US)

(21) Appl. No.: 14/741,782

(22) Filed: Jun. 17, 2015

(51) Int. Cl. G06F 9/50; G06F 9/455

(52) U.S. Cl. CPC G06F 9/50; G06F 9/45558; G06F 2009/4557

(57) ABSTRACT

Apparatuses, methods and storage media associated with managing operations of a virtual machine including dynamic idling and scheduling of virtual processors on logical processors described herein. In embodiments, an apparatus may include a physical computing platform with one or more physical processors, a virtual machine manager to manage operation of virtual machines each with a priority level and with one or more virtual processors that operate on logical processor instances of the one or more physical processors, wherein the virtual machine manager tracks activities of the virtual processors that operate on a shared logical processor instance and selectively idles and schedules one or more virtual processors in view of at least the activities of the virtual processors that operate on a shared logical processor instance and the priority of the virtual machines associated with the one or more virtual processors.

### TECHNICAL FIELD

The present disclosure relates to the field of computing. More particularly, the present disclosure relates to a virtual machine management method and apparatus that includes idling and scheduling virtual processors.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

A computer platform, operating a virtualized environment, will have multiple virtual machines running, each having one or more virtual processors. The computer platform will operate the virtualized environment on one or more logical processors of one or more physical processors. When multiple virtual processors are assigned to run on a logical processor, performance and latency problems may arise, particularly when virtual machines having different priorities compete for a shared logical processor. In particular, virtual processors associated with a lower priority virtual machine may be deprived of logical processor resources, resulting in performance issues for the lower priority virtual machine that it may be unable to detect.

### BRIEF DESCRIPTION OF THE DRAWINGS

Embodiments of the virtual machine management techniques of the present disclosure may overcome this limitation. The technique will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of a computing platform incorporated with the virtual machine management techniques of the present disclosure, according to various embodiments.

FIG. 2 is a flow diagram illustrating a method for managing the operation of virtual machines including idling and scheduling virtual processors, according to various embodiments.

FIG. 3 is a flow diagram illustrating a method for determining whether to schedule an idled virtual processor onto a logical processor, according to various embodiments.

FIG. 4 is a flow diagram illustrating a method for determining whether to schedule an idled virtual processor based on the priority of its associated virtual machine, according to various embodiments.

FIG. 5 is a flow diagram illustrating a method for determining whether to idle a virtual processor running on a logical processor, according to various embodiments.

FIG. 6 is a flow diagram illustrating a method for determining whether to idle a virtual processor based on the priority of its associated virtual machine, according to various embodiments.

FIG. 7 is a flow diagram illustrating a method for managing the idling and scheduling of virtual processors, according to various embodiments.

FIG. 8 illustrates a storage medium having instructions for practicing methods described with references to FIGS. 2-7, according to various embodiments.

### DETAILED DESCRIPTION

Apparatuses, methods and storage media associated with managing virtual machine operation are described herein. In embodiments, an apparatus may include a physical computing platform with one or more physical processors, and a virtual machine manager to manage operation of virtual machines each with a priority level and with one or more virtual processors that operate on logical processor instances of the one or more physical processors, wherein the virtual machine manager is to track activities of the virtual processors that operate on a shared logical processor instance and selectively idle and schedule one or more virtual processors in view of at least the activities of the virtual processors that operate on the shared logical processor instance and the priority of the virtual machines associated with the one or more virtual processors.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), a System on a Chip (SoC), an electronic circuit, a processor (shared, dedicated, or group) and/or memory (shared, dedicated, or group) that execute one or more software or firmware programs, a combinational logic circuit, and/or other suitable components that provide the described functionality.

The computing platform 102, except for the teaching of the present disclosure, may be any one of a number of computing devices known in the art, e.g., a system on a chip (SoC), a wearable device, a smartphone, a computing tablet, a notebook computer, a laptop computer, a desktop computer, a server, a set-top box, a game console, a camera, and so forth.

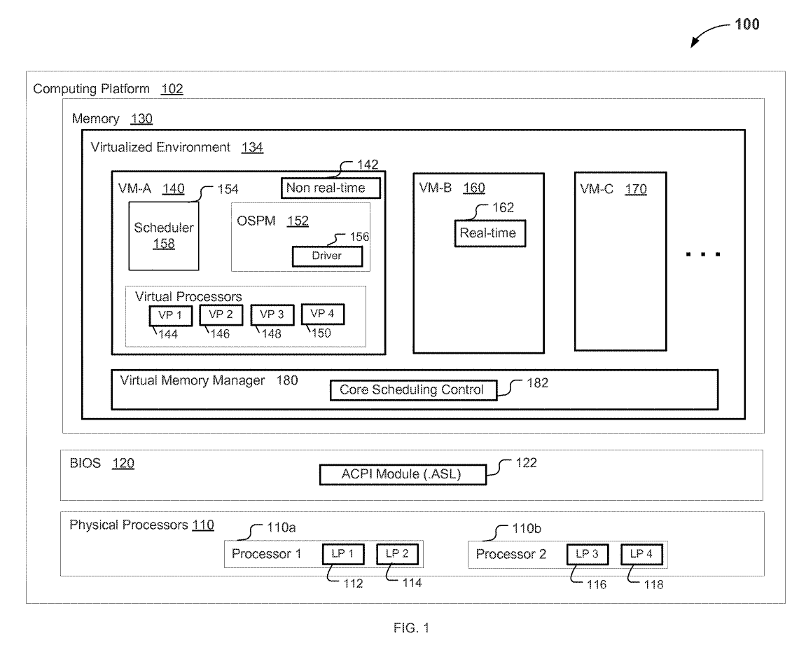

Referring now to FIG. 1, wherein a block diagram of a computing platform incorporated with the virtual machine management techniques of the present disclosure, according to various embodiments, is shown. As illustrated, computing platform 102 may include one or more physical processors 110, in embodiments a first physical processor 110a and/or a second physical processor 110b. Physical processors 110a/110b may contain one or more logical processors 112, 114, 116, 118, which may be used to execute computer-based instructions. The computing platform 102 may also include a basic input/output system (BIOS) 112 that may contain firmware modules, for example an Advanced Configuration and Power Interface (ACPI) module 112. In embodiments, the ACPI module 112 may provide operational information about or otherwise facilitate the operation of the one or more logical processors 112, 114, 116, 118. The computing platform 102 may include a memory 130 that may store data and/or one or more executable modules that may represent a virtualized environment 134.

A virtualized environment 134 may include one or more virtual machines 140, 160, 170 that may be managed by a virtual memory manager, VMM, 180. In FIG. 1, virtual machine B 160 and virtual machine C 170 may have components analogous to the components of virtual machine A 140. A virtual machine A 140 may include a priority 142 that may include an indication of the priority for one virtual machine in relation to another virtual machine. In embodiments, the priority may include one of real-time, as shown in priority 162 of virtual machine B 160, or non real-time as shown in priority 142 of virtual machine A 140. In embodiments, a virtual machine priority may be a numeric value.

In embodiments, virtual machine A 140 may also have one or more virtual processors 144, 146, 148, 150 that may execute one or more applications (not shown). The scheduler 158 may schedule execution of the applications. Further, in embodiments, the scheduler 158 may facilitate the operation of idling and scheduling of virtual processors 144, 146, 148, 150. In embodiments, idling a virtual processor may involve causing the virtual processor to enter an idle state to prevent it from executing computer-based instructions. Scheduling a virtual processor may involve causing the virtual processor to exit from an idle state so that the virtual processor may start executing computer-based instructions.

In embodiments, one or more scheduled virtual processors 144, 146, 148, 150 may be mapped to a logical processor 112, 114, 116, 118 that may be running on a physical processor 110a, 110b. In embodiments, when one or more virtual processors 144, 146, 148, 150, are idled, the virtual processors may no longer be mapped to a logical processor 112, 114, 116, 118.

A virtual machine 140 may also have an Operating System-directed configuration and Power Management (OSPM) module 152, which may interact with the VMM 180 and/or the scheduler 158 to facilitate the idling and scheduling of virtual processors 144, 146, 148, 150. The VMM 180 may provide a number of modules for providing scheduling and/or operational support services for the one or more virtual machines 140, 160, 170. The VMM 180 may include a core scheduling control module 182, which may facilitate monitoring of virtual machine activities, in particular the activities of virtual processors 144, 146, 148, 150 executing on logical processors 112, 114, 116, 118. In embodiments, the VMM 180 may have access to the performance statistics of the individual logical processors 112, 114, 116, 118.

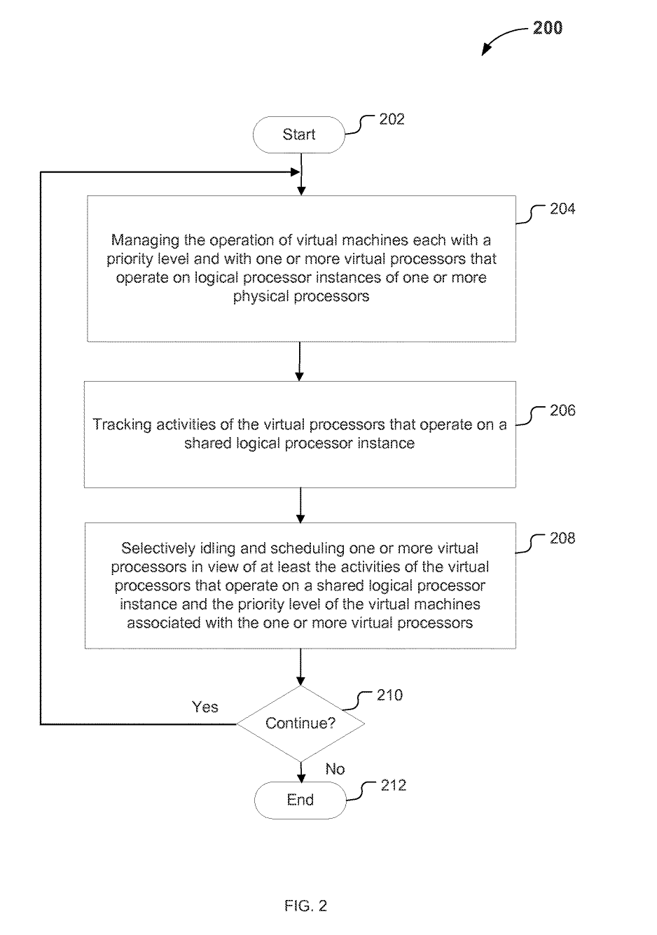

Referring now to FIG. 2, wherein a flow diagram showing a method 200 for managing the operation of virtual machines including idling and scheduling virtual processors, according to various embodiments, is illustrated. The method 200 may be performed by earlier described VMM 180. As shown, the method 200 may start at block 202.

At block 204, the operation of one or more virtual machines may be managed. The one or more virtual machines may have a priority and may have one or more virtual processors. The one or more virtual processors may be mapped to one or more logical processor instances of one or more physical processors.

At block 206, the activities of the virtual processors that operate on a shared logical processor instance may be tracked. In embodiments, the activities of the virtual processors of virtual machines 140, 160, 170 running in the virtualized environment 134 that are running on a shared logical processor 112, 114, 116, 118 may be tracked by the VMM 180. These activities may include current and historical resource utilization. Example of measures of these activities may include (but are not limited to): a ratio of processor compute time to processor idle time; interrupt rate; and other activity metrics. These activities may be tracked for both the shared logical processor and the one or more virtual processors being mapped to that shared logical processor. In embodiments, this activity may be tracked on a timed basis, for example, at least every 100 milliseconds.

At block 208, one or more virtual processors may be selectively idled and scheduled in view of at least the activities of the virtual processors that operate on the shared logical processor instance. In embodiments, the one or more virtual processors may be selectively idled and scheduled further in view of the priority of the virtual machines associated with the one or more virtual processors. As earlier described, a virtual machine 140 may have an associated priority 142. In embodiments, the virtual processors of a higher priority virtual machine may receive execution priority on a logical processor over the virtual processors of a lower priority virtual machine. For example, in a SoC architecture, real time communication processes such as modems, Wi-Fi processing, and the like that are executed as software modules inside a virtual machine may have a real-time priority. Even though the VMM 180 may schedule virtual processors of a non real-time virtual machine on the same logical processor as the real-time priority virtual processors, the result may be that the virtual processors of the virtual machine with real time processes may receive the majority of the logical processors resources, and the virtual processors of the virtual machine with non real-time processes may receive less of the logical processor resources. Nonetheless, there may be further performance improvements by idling the virtual processor of the virtual machine with non real-time processes, for some time, depending upon the activities of the shared logical processor and of the virtual processors mapped to the shared logical processor. These performance improvements may be seen through higher performance measurements for one or more virtual machines, and/or maintaining performance parity among the virtual machines.

At block 210, the method 200 may return to block 204 and continue therefrom, or may end at block 212, when operation of the virtual machines ends.

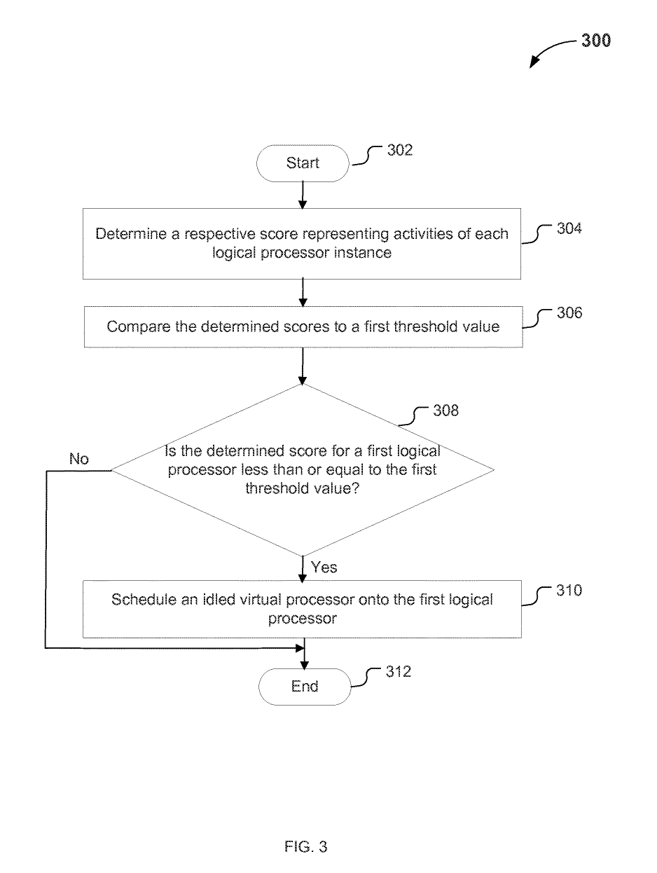

Referring now to FIG. 3, wherein a flow diagram 300 showing a method for determining whether to schedule an idled virtual processor onto a logical processor, according to various embodiments, is illustrated. The method 300 may be an example embodiment of block 208 shown in FIG. 2. The method 300 may be performed by earlier described VMM 180. As shown, the method 300 may start at block 302.

At block 304, a respective score representing activities of each logical processor instance may be determined. In embodiments, the score representing activities may be represented as a scalar value, or maybe represented as a vector of values representing various activities. In embodiments, a determined score may include evaluating and representing the activities of a shared logical processor captured at block 208. These activities may be tracked by the VMM 180 and may include processor utilization, interrupt rate, and/or other activity metrics. In embodiments, the score of a logical processor instance may not include the activities of the virtual processor to be scheduled onto the logical processor.

At block 306, the determined scores may be compared to a first threshold value. In embodiments, the first threshold value may be a scalar or a vector. In embodiments, the first threshold value may be configurable.

At block 308, a determination may be made on whether the score for a first logical processor is less than or equal to the first threshold value. If the score is less than or equal to the first threshold value, then at block 310 an idled virtual processor may be scheduled onto the first logical processor. In embodiments, a score for a first logical processor that is less than or equal to the first threshold value may indicate that the first logical processor is underutilized, and that resources of the first logical processor are available to support a scheduled virtual processor. If the score is greater than the first threshold value, then the method 300 may proceed to block 312.

The method 300 may end at block 312.

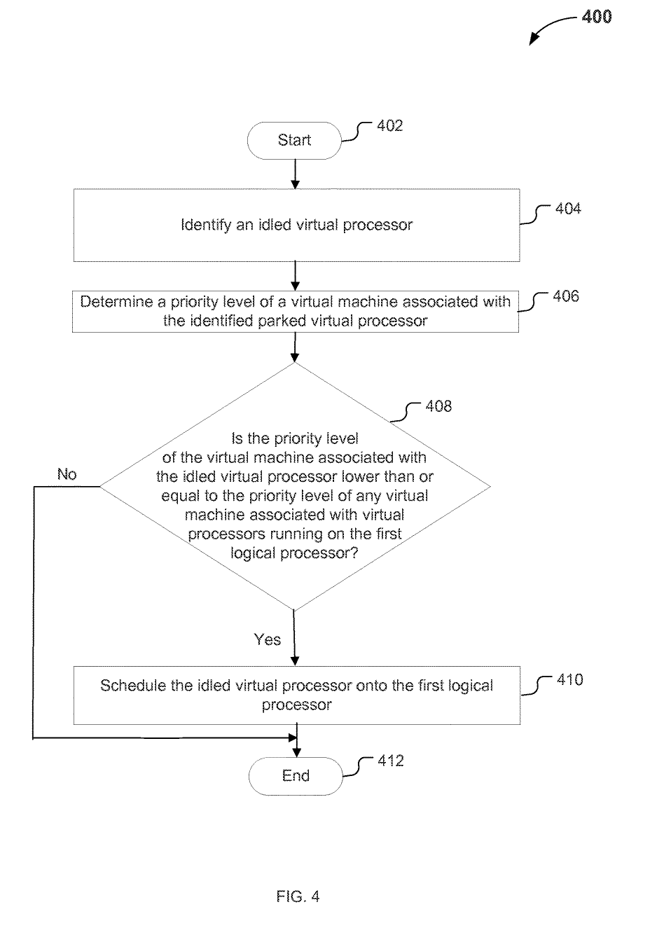

Referring now to FIG. 4, wherein a flow diagram 400 showing a method for determining whether to schedule an idled virtual processor based on the priority of its associated virtual machine, according to various embodiments, is illustrated. The method may be an example embodiment of block 310 of FIG. 3. The method 400 may be performed by the VMM 180. As shown, the method 400 may start at block 402.

At block 404, an idled virtual processor may be identified. In embodiments, this may be accomplished by data stored by or otherwise obtainable by the VMM 180.

At block 406, a priority of the virtual machine associated with the identified idled virtual processor may be determined. In embodiments, the priority may be one of real-time or non real-time.

At block 408, a determination may be made on whether the priority of the virtual machine associated with the idled virtual processor is lower than or equal to the priority of any virtual machine associated with virtual processors running on the first logical processor. If the priority of the virtual machine associated with the scheduled virtual processor is lower than or equal to the priority of any virtual machine associated virtual processors running on the first logical processor, then at block 410 the idled virtual processor may be scheduled onto the first logical processor. In embodiments, scheduling a virtual processor having an associated virtual machine with a priority lower than or equal to the virtual machine of any other virtual processor running on the logical processor may be used to schedule a virtual processor having a non real-time priority for execution on a logical processor. This may be the result of lower logical processor utilization because the activity of a real-time virtual processor running on the logical processor has decreased. As a result, the non real-time virtual processor is scheduled on the logical processor and begins to run so that performance of the non real-time virtual machine may increase and that virtual machine performance parity may be maintained.

Otherwise, if the priority of the virtual machine associated with the idled virtual processor is greater than the priority of any virtual machine associated virtual processors running on the first logical processor, the method 400 may go to block 412.

The method 400 may end at block 412.

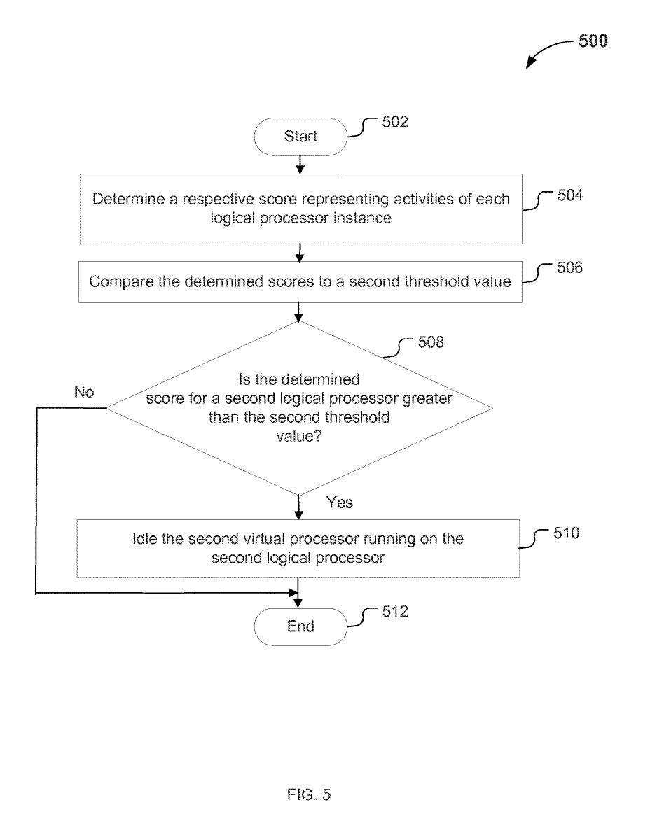

Referring now to FIG. 5, wherein a flow diagram 500 showing a method for determining whether to idle a virtual processor running a logical processor, according to various embodiments, is illustrated. The method 500 may be an example embodiment of block 208 shown in FIG. 2. The method 500 may be performed by the VMM 180. As shown, the method 500 may start at block 502.

At block 504, a respective score representing activities of each logical processor instance may be determined. In embodiments, the determined score may be a scalar or a vector. In embodiments, the score of a logical processor instance may not include the activities of the virtual processor to be idled.

At block 506, the determined scores may be compared to a second threshold value. In embodiments, the second threshold value may be a scalar or a vector.

At block 508, a determination may be made on whether the score for a second logical processor is greater than a second threshold value. If the score is greater than a second threshold value, then at block 510 the second virtual processor running on the second logical processor may be idled. In embodiments, a score for a second logical processor that is greater than a second threshold value may indicate that the second logical processor is resource constrained, and that a virtual processor running on the second logical processor may be idled to give other higher priority virtual processors running on the second logical processor additional resources.

If the score is less than or equal to a second threshold value, then the method 500 may go to block 512.

The method 500 may end at block 512.

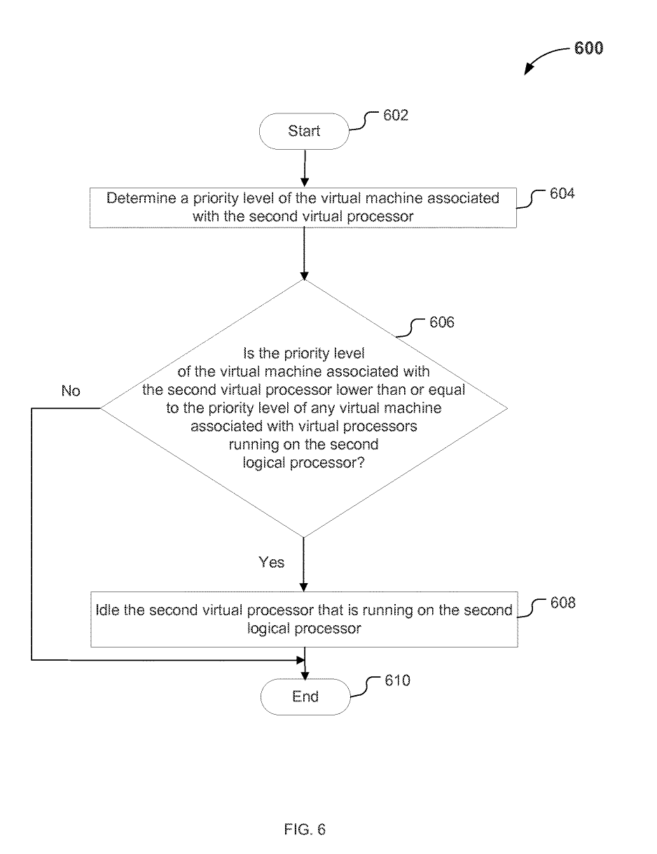

Referring now to FIG. 6, wherein a flow diagram 600 showing a method for determining whether to idle a virtual processor based on the priority of its associated virtual machine, according to various embodiments, is illustrated. The method may be an example embodiment of block 510 of FIG. 5. The method 600 may be performed by the VMM 180. As shown, the method 600 may start at block 602.

At block 604, a priority of the virtual machine associated with the second virtual processor may be determined. In embodiments, the priority may be one of real-time or non real-time.

At block 606, a determination may be made on whether the priority of the virtual machine associated with the second virtual processor is lower than or equal to the priority of any virtual machine associated with virtual processors running on the second logical processor. If the priority of the virtual machine associated with the second virtual processor is lower than or equal to the priority of any virtual machine associated with the virtual processor running on the second logical processor, then at block 608 the second virtual processor that is running on the second logical processor may be idled.

In embodiments, parking a virtual processor having an associated virtual machine with a priority lower than or equal to the virtual machine of any other virtual processor running on the logical processor may be used to park a virtual processor having a non real-time priority for execution on a logical processor. This may be because the utilization of the logical processor has increased such that performance of a real-time virtual processor executing on the logical processor may be substantially impairing the performance of a non real-time virtual processor. The non real-time virtual processor is idled so that the virtual machine associated with the idled virtual processor will know that there may be resource constraints on one or more logical processors.

Otherwise, if the priority of the virtual machine associated with the second virtual processor is greater than the priority of any virtual machine associated with virtual processors running on the second logical processor, then the method may continue to block 610.

The method 600 may end at block 610.

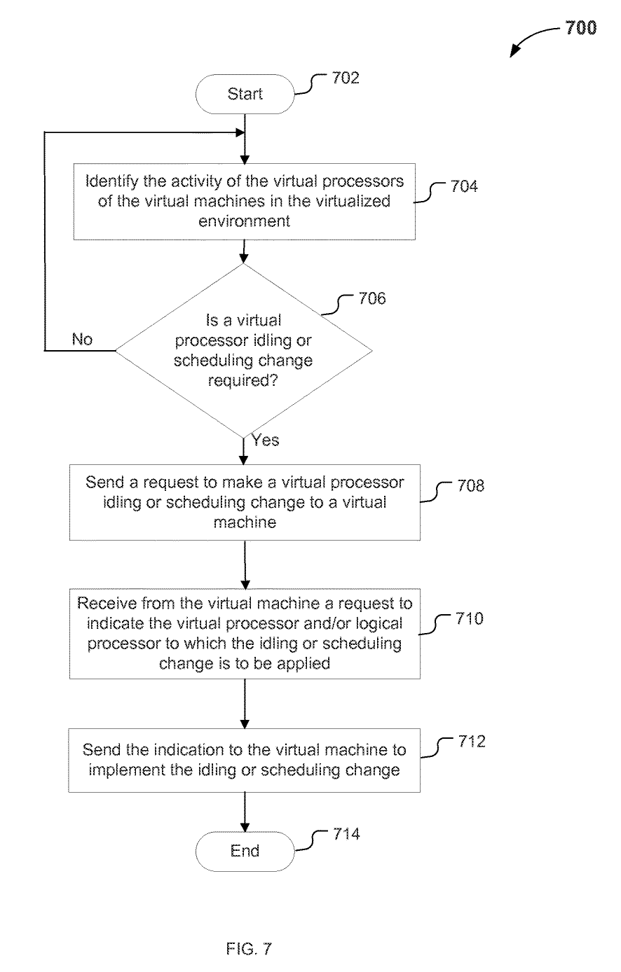

Referring now to FIG. 7, wherein a flow diagram 700 showing a method for managing the idling and scheduling of virtual processors, according to various embodiments, is illustrated. The method 700 may be performed by the VMM 180. As shown, the method 700 may start at block 702.

At block 704, activities of virtual processors of the virtual machines running in a virtualized environment may be identified. In embodiments, this operation may be performed by a core scheduling control module 182 running within VMM 180. In embodiments, the core scheduling control module 182 may interact with OSPM module 152 to initiate idling of a virtual processor. In embodiments, the core scheduling control module 182 may interact with other data and/or modules within VMM 180 to get information and/or activity information for some or all of the virtual processors running within the virtualized environment 134.

At block 706, a determination may be made on whether a virtual processor idling or scheduling change is required. In embodiments, the determination is made from the activities of the virtual processors, including activities of the one or more logical processors on which the virtual processors may be running, and the priority of the virtual processors based upon the priority of the virtual machine that is running the virtual processors. Embodiments may be described in FIGS. 2-7. If it is determined that a virtual processor idling or scheduling change is required, then the method 700 may proceed to block 708. If it is determined that a virtual processor idling or scheduling change is not required, then the method 700 may proceed to block 704.

At block 708, a request to make a virtual processor idling or scheduling change may be sent to a virtual machine. In embodiments, this request may be sent to the OSPM module 152 within a virtual machine 140. More particularly, the request may be sent to an OSPM driver 156.

At block 710, a request for an indication of a virtual processor and/or logical processor to which the idling or scheduling change is to be applied may be received from the virtual machine. In embodiments, this request may be received from the OSPM module 152 within a virtual machine 140. More particularly, the request may be received from an OSPM driver 156.

At block 712, a reply to the virtual machine with the indications is sent to the virtual machine. In embodiments, the virtual machine may implement the idling or scheduling change, for example scheduling the indicated virtual processor onto the indicated logical processor, or idling the indicated virtual processor running on the indicated logical processor.

The method 700 may end at block 714.

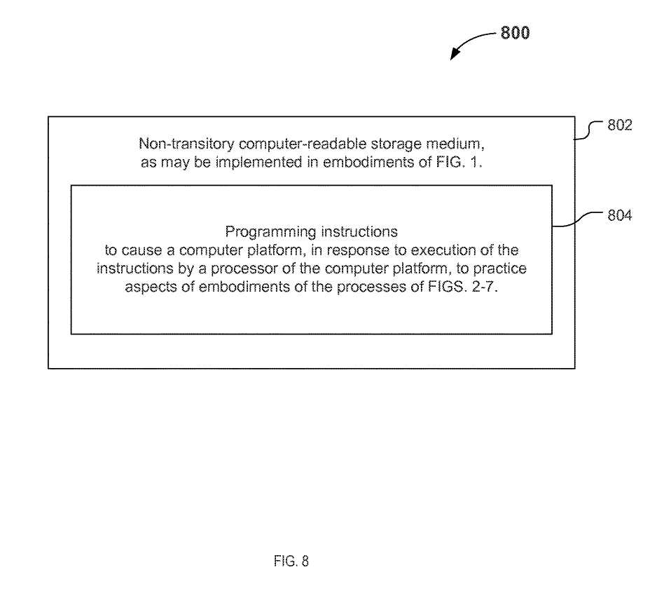

FIG. 8 illustrates a storage medium having instructions for practicing methods described with references to FIG. 2-7, according to various embodiments.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 6 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 802 may include a number of programming instructions 802. Programming instructions 804 may enable a device, e.g., computing platform 102, in response to execution of the programming instructions, to perform operations associated with BIOS 120, ACPI Module 122, virtual machines 140, 160, 180, Scheduler 158, OSPM 152, VMM 180 and/or Core Scheduling Control 182. In alternate embodiments, programming instructions 804 may be disposed on multiple computer-readable non-transitory storage media 802 instead. In alternate embodiments, programming instructions 804 may be disposed on computer-readable transitory storage media 802, such as signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Thus various example embodiments of the present disclosure have been described including, but are not limited to:

Example 1 may be an apparatus for computing, comprising: a physical computing platform with one or more physical processors; and a virtual machine manager, VMM, to manage operation of virtual machines each with a priority level and with one or more virtual processors that operate on logical processor instances of the one or more physical processors, wherein the VMM is to track activities of the virtual processors that operate on a shared logical processor instance and selectively idle and schedule one or more virtual processors in view of at least the activities of the virtual processors that operate on the shared logical processor instance and the priority level of the virtual machines associated with the one or more virtual processors.

Example 2 may be example 1, wherein the priority level of each virtual machine is a selected one of real-time and non real-time, and wherein the real-time priority level is higher than the non real-time priority level.

Example 3 may be example 1, wherein to track activities of the virtual processors that operate logical processor instances, the VMM is to track utilization, interrupt rates and/or other activity metrics of the logical processor instances.

Example 4 may be any one of examples 1-3, wherein to selectively schedule the one or more virtual processor instances, the VMM is to: determine a respective score that represents activities of each logical processor instance; compare the determined scores to a first threshold value; schedule an idled virtual processor onto a logical processor only if the determined score of the logical processor is lower than the first threshold value.

Example 5 may be example 4 wherein schedule an idled virtual processor onto a logical processor further includes schedule the idled virtual processor onto a logical processor only if the priority level of the virtual machine associated with the idled virtual processor is lower than or equal to the priority level of any virtual machine associated with virtual processors that run on the logical processor.

Example 6 may be any one of examples 1-3, wherein to selectively idle the one or more virtual processor instances, the VMM is to: determine a respective score that represents activities of each logical processor instance; compare the determined scores to a second threshold value; idle a first virtual processor, that runs on a logical processor, with a priority level of a virtual machine associated with the first virtual processor that is lower than the priority level of a virtual machine associated with a second virtual processor that runs on the logical processor, only if the determined score of the logical processor is greater than the second threshold value.

Example 7 may be a computer-based method comprising: managing, by a virtual machine monitor, VMM, the operation of virtual machines each with a priority level and with one or more virtual processors that operate on logical processor instances of one or more physical processors; tracking, by the VMM, activities of the virtual processors that operate on a shared logical processor instance; and selectively idling and scheduling, by the VMM, one or more virtual processors in view of at least the activities of the virtual processors that operate on a shared logical processor instance and the priority level of the virtual machines associated with the one or more virtual processors.

Example 8 may be example 7, wherein selectively scheduling the one or more virtual processors further includes: determining, by the VMM, a respective score representing activities of each logical processor instance; comparing, by the VMM, the determined scores to a first threshold value; scheduling, by the VMM, an idled virtual processor onto a first logical processor only if the determined score for the first logical processor is less than or equal to the first threshold value.

Example 9 may be example 8, wherein scheduling an idled virtual processor onto a first logical processor further includes scheduling the idled virtual processor onto a first logical processor only if the priority level of the virtual machine associated with the idled virtual processor is lower than or equal to the priority level of any virtual machine associated with virtual processors running on the first logical processor.

Example 10 may be example 7, wherein selectively idling the one or more virtual processors further includes: determining, by the VMM, a respective score representing activities of each logical processor instance; comparing, by the VMM, the determined scores to a second threshold value; idling, by the VMM, a second virtual processor running on a second logical processor only if determined score of the second logical processor is greater than the second threshold value.

Example 11 may be example 10, wherein idling a second virtual processor running on a second logical processor further includes idling a second virtual processor running on a second logical processor only if the priority level of a virtual machine associated with the second virtual processor is lower than or equal to the priority level of any virtual machine associated with any virtual processor running on the second logical processor.

Example 12 may be any one of examples 8-11, wherein determining a respective score representing activities of each logical processor instance is a function of at least utilization, interrupt rates and/or other activity metrics of the logical processor instance.

Example 13 may be any one of examples 7-11, wherein the priority level of a virtual machine is a selected one of real-time and non real-time, real-time having a higher priority than non real-time.

Example 14 may be one or more computer-readable media comprising instructions that cause a computing device, in response to execution of the instructions by the computing device, to: manage, by a virtual machine monitor, VMM, the operation of virtual machines each with a priority level and with one or more virtual processors that operate on logical processor instances of one or more physical processors; track, by the VMM, activities of the virtual processors that operate on a shared logical processor instance; and selectively idle and schedule, by the VMM, one or more virtual processors in view of at least the activities of the virtual processors that operate on a shared logical processor instance and the priority level of the virtual machines associated with the one or more virtual processors.

Example 15 may be example 14, wherein selectively schedule the one or more virtual processors further includes: determine, by the VMM, a respective score representing activities of each logical processor instance; compare, by the VMM, the determined scores to a first threshold value; schedule, by the VMM, an idled virtual processor onto a first logical processor only if the determined score for the first logical processor is less than or equal to the first threshold value.

Example 16 may be example 15, wherein schedule an idled virtual processor onto a first logical processor further includes schedule the idled virtual processor onto a first logical processor only if the priority level of the virtual machine associated with the idled virtual processor is lower than or equal to the priority level of any virtual machine associated with virtual processors running on the first logical processor.

Example 17 may be example 14, wherein selectively idle the one or more virtual processors further includes: determine, by the VMM, a respective score representing activities of each logical processor instance; compare, by the VMM, the determined scores to a second threshold value; idle, by the VMM, a second virtual processor running on a second logical processor only if determined score of the second logical processor is greater than the second threshold value.

Example 18 may be example 17, wherein idle a second virtual processor running on a second logical processor further includes idle a second virtual processor running on a second logical processor only if the priority level of a virtual machine associated with the second virtual processor is lower than or equal to the priority level of any virtual machine associated with any virtual processor running on the second logical processor.

Example 19 may be any one of examples 15-18, wherein determine a respective score representing activities of each logical processor instance is a function of at least utilization, interrupt rates and/or other activity metrics of the logical processor instance.

Example 20 may be any one of examples 14-18, wherein the priority level of a virtual machine is a selected one of real-time and non real-time, real-time having a higher priority than non real-time.

Example 21 may be a computing device, comprising: means for managing the operation of virtual machines each with a priority level and with one or more virtual processors that operate on logical processor instances of one or more physical processors; means for tracking activities of the virtual processors that operate on a shared logical processor instance; and means for selectively idling and scheduling one or more virtual processors in view of at least the activities of the virtual processors that operate on a shared logical processor instance and the priority level of the virtual machines associated with the one or more virtual processors.

Example 22 may be example 21, wherein selectively scheduling the one or more virtual processors comprises means for determining a respective score representing activities of each logical processor instance, means for comparing the determined scores to a first threshold value, and means for scheduling and idled virtual processor onto a first logical processor only if the determined score for the first logical processor is less than or equal to the first threshold value.

Example 23 may be example 22, wherein means for scheduling a parked virtual processor onto a first logical processor further comprises means for scheduling the idled virtual processor onto a first logical processor only if the priority level of the virtual machine associated with the idled virtual processor is lower than or equal to the priority level of any virtual machine associated with virtual processors running on the first logical processor.

Example 24 may be example 21, wherein means for selectively idling the one or more virtual processors comprises means for determining a respective score representing activities of each logical processor instance, means for comparing the determined scores to a second threshold value, and means for idling a second virtual processor running on a second logical processor only if determined score of the second logical processor is greater than the second threshold value.

Example 25 may be example 24, wherein means for idling a second virtual processor running on a second logical processor further includes idling a second virtual processor running on a second logical processor only if the priority level of a virtual machine associated with the second virtual processor is lower than or equal to the priority level of any virtual machine associated with any virtual processor running on the second logical processor.

Example 26 may be any one of examples 21-25, wherein means for determining a respective score representing activities of each logical processor instance is a function of at least utilization, interrupt rates and/or other activity metrics of the logical processor instance.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. An apparatus for computing, comprising:
a physical computing platform with one or more physical processors; and
a virtual machine manager, VMM, to manage operation of virtual machines each with a priority level and with one or more virtual processors that operate on logical processor instances of the one or more physical processors, wherein the VMM is to track activities of the virtual processors that operate on a shared logical processor instance and selectively idle and schedule one or more virtual processors in view of at least the activities of the virtual processors that operate on the shared logical processor instance and the priority level of the virtual machines associated with the one or more virtual processors.

2. The apparatus of claim 1, wherein the priority level of each virtual machine is a selected one of real-time and non real-time, and wherein the real-time priority level is higher than the non real-time priority level.

3. The apparatus of claim 1, wherein to track activities of the virtual processors that operate logical processor instances, the VMM is to track utilization, interrupt rates and/or other activity metrics of the logical processor instances.

4. The apparatus of claim 3, wherein to selectively schedule the one or more virtual processor instances, the VMM is to:
determine a respective score that represents activities of each logical processor instance;
compare the determined scores to a first threshold value;
schedule an idled virtual processor onto a logical processor only if the determined score of the logical processor is lower than the first threshold value.

5. The apparatus of claim 4 wherein schedule an idled virtual processor onto a logical processor further includes schedule the idled virtual processor onto a logical processor only if the priority level of the virtual machine associated with the idled virtual processor is lower than or equal to the priority level of any virtual machine associated with virtual processors that run on the logical processor.

6. The apparatus of claim 3, wherein to selectively idle the one or more virtual processor instances, the VMM is to:
determine a respective score that represents activities of each logical processor instance;
compare the determined scores to a second threshold value;
idle a first virtual processor, that runs on a logical processor, with a priority level of a virtual machine associated with the first virtual processor that is lower than the priority level of a virtual machine associated with a second virtual processor that runs on the logical processor, only if the determined score of the logical processor is greater than the second threshold value.

7. A computer-based method comprising:
managing, by a virtual machine monitor, VMM, the operation of virtual machines each with a priority level and with one or more virtual processors that operate on logical processor instances of one or more physical processors;
tracking, by the VMM, activities of the virtual processors that operate on a shared logical processor instance; and
selectively idling and scheduling, by the VMM, one or more virtual processors in view of at least the activities of the virtual processors that operate on a shared logical processor instance and the priority level of the virtual machines associated with the one or more virtual processors.

8. The computer-based method of claim 7, wherein selectively scheduling the one or more virtual processors further includes:
determining, by the VMM, a respective score representing activities of each logical processor instance;
comparing, by the VMM, the determined scores to a first threshold value;
scheduling, by the VMM, an idled virtual processor onto a first logical processor only if the determined score for the first logical processor is less than or equal to the first threshold value.

9. The computer-based method of claim 8, wherein scheduling an idled virtual processor onto a first logical processor further includes scheduling the idled virtual processor onto a first logical processor only if the priority level of the virtual machine associated with the idled virtual processor is lower than or equal to the priority level of any virtual machine associated with virtual processors running on the first logical processor.

10. The computer-based method of claim 7, wherein selectively idling the one or more virtual processors further includes:
determining, by the VMM, a respective score representing activities of each logical processor instance;
comparing, by the VMM, the determined scores to a second threshold value;
idling, by the VMM, a second virtual processor running on a second logical processor only if determined score of the second logical processor is greater than the second threshold value.

11. The computer-based method of claim 10, wherein idling a second virtual processor running on a second logical processor further includes idling a second virtual processor running on a second logical processor only if the priority level of a virtual machine associated with the second virtual processor is lower than or equal to the priority level of any virtual machine associated with any virtual processor running on the second logical processor.

12. The computer-based method of claim 8, wherein determining a respective score representing activities of each logical processor instance is a function of at least utilization, interrupt rates and/or other activity metrics of the logical processor instance.

13. The computer-based method of claim 7, wherein the priority level of a virtual machine is a selected one of real-time and non real-time, real-time having a higher priority than non real-time.

14. One or more computer-readable media comprising instructions that cause a computing device, in response to execution of the instructions by the computing device, to:
manage, by a virtual machine monitor, VMM, the operation of virtual machines each with a priority level and with one or more virtual processors that operate on logical processor instances of one or more physical processors;
track, by the VMM, activities of the virtual processors that operate on a shared logical processor instance; and
selectively idle and schedule, by the VMM, one or more virtual processors in view of at least the activities of the virtual processors that operate on a shared logical processor instance and the priority level of the virtual machines associated with the one or more virtual processors.

15. The one or more computer-readable media of claim 14, wherein selectively schedule the one or more virtual processors further includes:
determine, by the VMM, a respective score representing activities of each logical processor instance;
compare, by the VMM, the determined scores to a first threshold value;
schedule, by the VMM, an idled virtual processor onto a first logical processor only if the determined score for the first logical processor is less than or equal to the first threshold value.

16. The one or more computer-readable media of claim 15, wherein schedule an idled virtual processor onto a first logical processor further includes schedule the idled virtual processor onto a first logical processor only if the priority level of the virtual machine associated with the idled virtual processor is lower than or equal to the priority level of any virtual machine associated with virtual processors running on the first logical processor.

17. The one or more computer-readable media of claim 14, wherein selectively idle the one or more virtual processors further includes:
determine, by the VMM, a respective score representing activities of each logical processor instance;
compare, by the VMM, the determined scores to a second threshold value;
idle, by the VMM, a second virtual processor running on a second logical processor only if determined score of the second logical processor is greater than the second threshold value.

18. The one or more computer-readable media of claim 17, wherein idle a second virtual processor running on a second logical processor further includes idle a second virtual processor running on a second logical processor only if the priority level of a virtual machine associated with the second virtual processor is lower than or equal to the priority level of any virtual machine associated with any virtual processor running on the second logical processor.

19. The one or more computer-readable media of claim 15, wherein determine a respective score representing activities of each logical processor instance is a function of at least utilization, interrupt rates and/or other activity metrics of the logical processor instance.

20. The one or more computer-readable media of claim 14, wherein the priority level of a virtual machine is a selected one of real-time and non real-time, real-time having a higher priority than non real-time.

21. A computing device, comprising:
means for managing the operation of virtual machines each with a priority level and with one or more virtual processors that operate on logical processor instances of one or more physical processors;
means for tracking activities of the virtual processors that operate on a shared logical processor instance; and
means for selectively idling and scheduling one or more virtual processors in view of at least the activities of the virtual processors that operate on a shared logical processor instance and the priority level of the virtual machines associated with the one or more virtual processors.

22. The computing device of claim 21, wherein selectively scheduling the one or more virtual processors comprises means for determining a respective score representing activities of each logical processor instance, means for comparing the determined scores to a first threshold value, and means for scheduling and idled virtual processor onto a first logical processor only if the determined score for the first logical processor is less than or equal to the first threshold value.

23. The computing device of claim 22, wherein means for scheduling a parked virtual processor onto a first logical processor further comprises means for scheduling the idled virtual processor onto a first logical processor only if the priority level of the virtual machine associated with the idled virtual processor is lower than or equal to the priority level of any virtual machine associated with virtual processors running on the first logical processor.

24. The computing device of claim 21, wherein means for selectively idling the one or more virtual processors comprises means for determining a respective score representing activities of each logical processor instance, means for comparing the determined scores to a second threshold value, and means for idling a second virtual processor running on a second logical processor only if determined score of the second logical processor is greater than the second threshold value.

25. The computing device of claim 24, wherein means for idling a second virtual processor running on a second logical processor further includes idling a second virtual processor running on a second logical processor only if the priority level of a virtual machine associated with the second virtual processor is lower than or equal to the priority level of any virtual machine associated with any virtual processor running on the second logical processor.
